(19) United States
(12) Patent Application Publication
(10) Pub. No.: US 2010/0201875 A1
(43) Pub. Date: Aug. 12, 2010

(54) SELF-CONTAINED AUDIO/VISUAL PRESENTATION SYSTEM, METHODS AND NETWORKS FOR PROVIDING VIDEO PRESENTATION SERVICES, AND METHODS FOR ACCESSING AND USING THE VIDEO PRESENTATION SERVICES

(76) Inventors: Richard K. Rood, Henderson, NV (US); Robert M. Long, Alpine, UT (US); David A. Daniels, Basalt, CO (US)

Correspondence Address: Durham, Jones & Pinegar --;Intellectual Property Law Group, P.O. Box 4050, Salt Lake City, UT, 84110, US

(21) Appl. No.: 12/684,473

(22) Filed: Jan. 8, 2010

Related U.S. Application Data
(60) Provisional application No. 61/143,756, filed on Jan. 9, 2009.
(60) Provisional application No. 61/143,759, filed on Jan. 9, 2009.
(60) Provisional application No. 61/143,761, filed on Jan. 9, 2009.

(51) Int. Cl. H04N 7/00

(52) U.S. Cl. 348/552; 348/E07.001

(57) ABSTRACT

A self-contained audio/visual presentation system for ease of use. In networks and methods for providing audio/visual presentation systems to facilitators, such as meeting facilities, and by the facilitators to customers of the facilitator, an owner supplies one or more audio/visual presentation systems to a facilitator without relinquishing at least some of its rights to the audio/visual presentation system. The facilitator rents the audio/visual presentation system to its customers. The facilitator compensates the owner for each use of the audio/visual presentation system. A user may obtain an access validation, use the access validation to actuate (e.g., turn on) an audio/visual presentation system, and operate the audio/visual presentation system.

### CROSS-REFERENCE TO RELATED APPLICATIONS

This application claims the benefit of U.S. Provisional Application No. 61/143,756, filed Jan. 8, 2009, U.S. Provisional Application No. 61/143,759, filed Jan. 8, 2009, and U.S. Provisional Application No. 61/143,761, filed Jan. 8, 2009, the disclosure of each of which is hereby incorporated herein, in its entirety, by this reference.

### TECHNICAL FIELD

The present invention, in various embodiments, relates generally to audio/visual presentation systems and, more specifically to self-contained audio/visual presentation systems that are configured for ease of use.

The present invention also relates to methods by which audio/visual presentation systems are provided to facilitators, such as meeting facilities, and by the facilitators to customers of the facilitator. In a particular embodiment, the present invention relates to a business method in which an owner supplies one or more audio/visual presentation systems to a facilitator without relinquishing at least some of its rights to the audio/visual presentation system, the facilitator rents the audio/visual presentation system to its customers, and the facilitator compensates the owner for each use of the audio/visual presentation system. The present invention also includes networks including the owner, a number of meeting facilities, and, optionally, third party service contractors.

In addition, the present invention relates generally to video presentation methods and systems and, more specifically, to methods for presenting video and accompanying audio on another party's audio/visual presentation systems. In particular, the present invention relates to methods in which a user obtains an access validation, uses the access validation to actuate (e.g., turn on) an audio/visual presentation system, and operates the audio/visual presentation system. Audio/visual presentation systems that require a user to provide access validation prior to operating are also within the scope of the present invention.

### RELATED ART

Currently, audio/visual presentation systems that are configured for use in conference rooms, assembly halls, convention centers, and other meeting rooms include a number of separate components that must be assembled. A typical audio/visual presentation system includes components such as a video display and various sound system components, such as a mixer, amplifier, and speakers.

The assembly of these components with one another is typically quite complex, as the components must be properly connected to one another, usually with an array of different types of cables, and adjusted to function in concert with one another. Because of the complexity that is typically involved in setting up and taking down conventional audio/visual presentation systems, these functions are frequently performed by skilled technicians who charge a premium for their services. Even when a skilled technician is employed to set up a conventional audio/visual presentation system, it typically takes a half an hour or forty-five minutes to complete the process.

Oft times, skilled technicians must also be employed to couple a user's equipment to the audio/visual presentation system, to train the user to properly operate the audio/visual presentation system, and to remain onsite during the user's presentation to ensure that the presentation system will function properly in conjunction with the user's equipment.

Parties that conduct meetings often do so away from their own offices, or “offsite,” at a location such as a convention center, a hotel conference room, or another meeting facility. When audio/visual presentation equipment is needed for an offsite meeting, the party that conducts the meeting either has to transport and set up its own presentation equipment, or contract with the meeting facility or a third party to provide and set up the necessary audio/visual presentation equipment.

Currently, audio/visual presentation systems that are configured for use in conference rooms, assembly halls, convention centers, and other meeting rooms include a number of separate components that must be assembled. A typical audio/visual presentation system includes a number of separate components such as a video display and various sound system components, such as a mixer, amplifier, and speakers.

The assembly of these components with one another is typically quite complex, as the components must be properly connected to one another, usually with an array of different types of cables, and adjusted to function in concert with one another. Because of the complexity that is typically involved in setting up and taking down conventional audio/visual presentation systems, these functions are frequently performed by skilled technicians who charge a premium for their services. Even when a skilled technician is employed to set up a conventional audio/visual presentation system, it typically takes a half an hour or forty-five minutes to complete the process.

Often, skilled technicians must also be employed to couple a user's equipment to the audio/visual presentation system, to train the user to properly operate the audio/visual presentation system, and to remain onsite during the user's presentation to ensure that the presentation system will function properly in conjunction with the user's equipment.

When a meeting facility has its own audio/visual presentation equipment onsite, the meeting facility has invested significant time to identify and select components that will satisfy their customers, and significant capital to purchase such equipment. In addition to that cost, the meeting facility has to employ skilled individuals who have the technical know-how to set up and use the audio/visual presentation equipment, train the parties who will be conducting meetings with the presentation equipment to properly use the presentation equipment, resolve any issues during use of the presentation equipment, take the presentation equipment down, and maintain the presentation equipment. Meeting facilities that own their own audio/visual presentation equipment must also bear the costs associated with maintaining and replacing such equipment.

The difficulties that are involved with owning and maintaining audio/visual presentation equipment may be avoided by contracting with third party providers. However, third party contractors typically charge a premium for use of their equipment and services, and they or their equipment may not be available during the times it is needed by the customers of a meeting facility.

### SUMMARY

The present invention includes self-contained audio/visual presentation systems that are configured for use without the assistance of, or with minimal assistance from, skilled technicians. For the sake of simplicity, audio/visual presentation systems according to various embodiments of the present invention are also referred to as “presentation systems.”

An embodiment of a presentation system of the present invention includes a frame that carries a number of preassembled components, including a controller, a video display, and a discrete sound system. The controller is configured to establish communication with a source of digital video data (e.g., by a single connection) that has been provided by a user. The controller is also configured to control operation of the video display and the sound system. Once communication has been established between the controller and the source of digital video data, the controller receives video and, in some embodiments, audio signals from the source of digital video data. The controller may transmit a video-only signal directly to the video display and, if present, a separate audio-only signal directly to the sound system.

The presentation system may also include a user access device in association with the controller. In such embodiments, the user access device may be configured to restricts operation of the controller and, thus, of the remainder of the presentation system until the user access device receives valid user access data.

The present invention also includes various embodiments of presentation methods. In use, a source of digital video data, such as a computer or a memory device, communicates with the controller of an embodiment of presentation system. Such communication may be effected simply by coupling a single cable from the source of digital video data to the controller, or by establishing a wireless connection between the source of digital video data and the controller. The digital video data may then be conveyed from the source to the controller and, when instructed, the source or the controller may separately transmit video signals and audio signals to the video display and sound system, respectively, of the presentation system.

In embodiments where the presentation system includes an active user access device, a user may be required to input valid access data before the presentation system will function. In some embodiments, input of valid access data is required prior to actuation of (e.g., providing power to, turning on, etc.) one or more other components of the presentation system. In other embodiments, valid access data must be input before the controller will receive digital video data from a source of the digital video data or before the controller will transmit digital video and/or audio data to other components of the presentation system.

The present invention also includes various embodiments of a method by which audio/visual presentation systems are provided to a facilitator, such as a meeting facility, and made available to customers of the facilitator (e.g., users of the meeting facility, etc.). For the sake of simplicity, audio/visual presentation systems are also referred to herein as “presentation systems.” Networks and methods that incorporate teachings of the present invention may, however, include use of any type of audio/visual presentation system.

In the present invention, an owner places presentation equipment in possession of a facilitator while retaining rights to the presentation equipment. In some embodiments, the owner also retains responsibility for maintaining and servicing the presentation equipment.

The facilitator provides its customers with access to the presentation equipment, who may rent the presentation equipment from the facilitator. The facilitator compensates the owner by paying a usage fee to the owner each time the presentation equipment is used (e.g., each time one of the facilitator's customers rents the presentation equipment, etc.). In some embodiments, the facilitator may be obligated to pay the owner a minimum periodic (e.g., monthly) usage fee.

The owner may contract with a third party dealer to maintain the presentation equipment and, in some embodiments, to provide technical support to the facilitator or the parties using the presentation equipment.

The present invention also includes embodiments of networks including an owner, one or more facilitators to which one or more presentation systems have been provided by the owner, and, optionally, a service provider under contract with the owner to service and/or provide support services to one or more facilitators and their customers.

In an audio/visual presentation method according to embodiments of the present invention, a party uses an audio/visual presentation system, or, more simply, a “presentation system,” at a location where a meeting is to be conducted. That location is remote (i.e., away, offsite, etc.) from the party's usual place of business. In such a method, the user may reserve the presentation system, obtain an access validation for operation of the presentation system, and operate the presentation system.

The present invention also includes presentation systems that only operate when activated or activated when valid access information or data is provided. In various embodiments, such a presentation system may include a controller that communicates with a media source provided by the user and that controls operation of the various video and audio components of the presentation system. Some embodiments may include an access device, which receives the access information or data, associated with the controller.

Other aspects, as well as the features and advantages of each aspect of the present invention, will become apparent to those of ordinary skill in the art through consideration of the ensuing description, the accompanying drawings, and the appended claims.

### BRIEF DESCRIPTION OF THE DRAWINGS

In the drawings:

FIG. 1 is a schematic representation of an embodiment of audio/visual presentation system of the present invention;

FIG. 2 is a schematic representation of another embodiment of audio/visual presentation system of the present invention;

FIG. 3 is schematic representation of an embodiment of a network through which audio/visual presentation systems and services are provided to customers who will only temporarily use the same;

FIG. 4 is a schematic representation illustrating an embodiment of use of a presentation system; and

FIG. 5 is a schematic representation of an embodiment of audio/visual presentation system of the present invention, which only operates when appropriate access validation has been provided.

### DETAILED DESCRIPTION

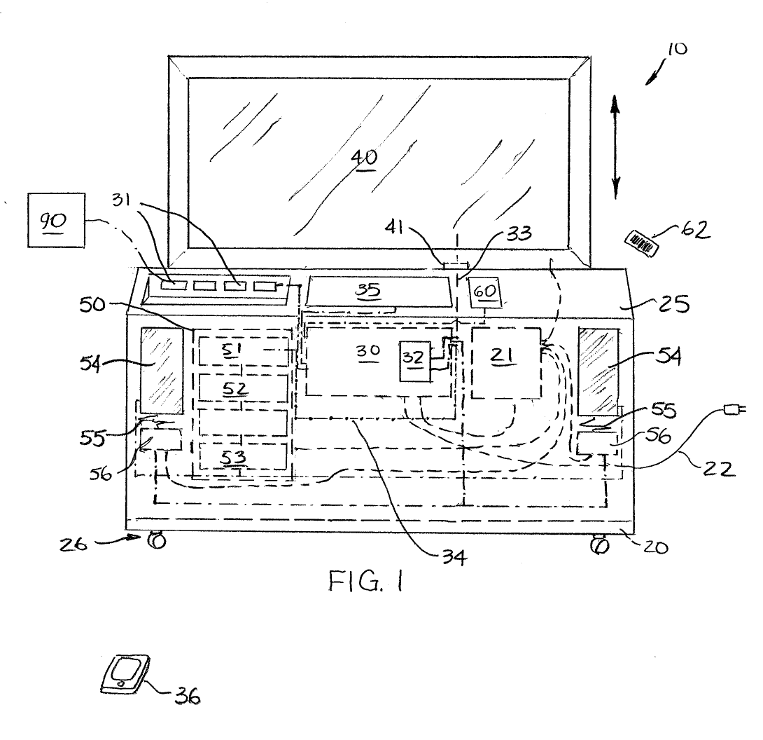

As shown in FIG. 1, an embodiment of a presentation system 10 of the present invention includes a frame 20, a controller 30, a video display 40, and a sound system 50. Controller 30, video display 40, and sound system 50 are affixed to or otherwise carried by frame 20. A housing 25 may surround and contain frame 20, as well as portions of controller 30, video display 40, and sound system 50. In some embodiments, video display 40 may be extendable from and retractable into housing 25. Controller 30 communicates with video display 40 and sound system 50 by way of various cables 60 (e.g., power cables, video cables, audio cables, etc.). Presentation system 10 may also include a central power supply 21. Additionally, movement of presentation system 10 from one location to another may be facilitated by way of a transport system 26 (e.g., wheels, etc.) associated with frame 20.

Central power supply 21 may include a power cord 22 for receiving power from an external source (e.g., an electrical receptacle in the wall of a room, etc.), as well as various other components (e.g., a rectifier, one or more electrical converters, one or more transformers, etc.), and may be configured to supply power to controller 30, video display 40, and sound system 50. In the depicted embodiment, central power supply 21 is associated with controller 30. In some embodiments, central power supply 21 may be a part of controller 30.

Controller 30 communicates with a separate source 90 (e.g., a computer, a memory device, etc.), which is typically provided by a user of presentation system 10, to receive digital video data, along with any corresponding digital audio data, from source 90. Communication between controller 30 and source 90 may be established through a port 31. In various embodiments, port 31 may comprise a VGA connector, an S-video connector, an HDMI connector, a memory card receptacle (e.g., a secure digital (SD) card slot, a compact flash (CF) card slot, etc.), or the like.

Controller 30 includes at least one processing element 32, which may be programmed to perform a variety of functions. One of the functions of processing element 32 is the processing of a digital video signal, which may also include a digital audio component. Another function of processing element 32 is the transmission of separate video and audio signals to video display 40 and sound system 50, respectively. More specifically, a video signal, which carries digital video data, may be transmitted from processing element 32 to video display 40 along a video output element 33, while an audio signal may be transmitted from processing element 32 to sound system 50 by way of an audio output element 34.

In addition, processing element 32 of controller 30 may be programmed to control operation of video display 40 and sound system 50 in a manner known in the art. Processing element 32 of controller 30 may also, in some embodiments, be programmed to provide some control over the transmission of digital video data by source 90.

Processing element 32 may also be programmed to limit the use of presentation system 10 to individuals who have obtained valid access information, or data (e.g., a valid access code, etc.). In some embodiments, access information that is provided to user and input into processing element 32 may include information about a time range over which the user has received access to presentation system 10, and limit operation of presentation system 10 to that time range.

Controller 30 or processing element 32 thereof may be embodied in any manner suitable to enable it to perform its various functions. In some embodiments, controller 30 or its processing element 32 may comprise an appropriately configured audio/video receiver. In other embodiments, controller 30 or its processing element 32 may comprise a computer. Alternative embodiments of controller 30 or its processing element include specialized circuitry, including, but not limited to, microcontrollers, circuit boards, memory elements, and other electronic components that have been assembled with one another and function together in a manner that will enable controller 30 to function in a desired manner.

As indicated previously, controller 30 may also serve as (i.e., include) or otherwise be associated with central power supply 21 for presentation system 10. In some embodiments, controller 30 manages the transmission of power to other components of presentation system 10, including the transmission of power to video display 40 and to various components of sound system 50.

Operation of controller 30 may be effected through a user interface 35 (e.g., a touch-sensitive screen, buttons, knobs, etc.) on presentation system 10. Additionally, in some embodiments, controller 30 may be equipped to receive control signals from a separate remote control 36 in a manner known in the art (e.g., through an infrared communication port).

Video display 40 may comprise any suitable video display device known in the art. In the embodiment illustrated by FIG. 1, video display 40 comprises a flat panel display, such as an LCD (liquid crystal display) or plasma monitor.

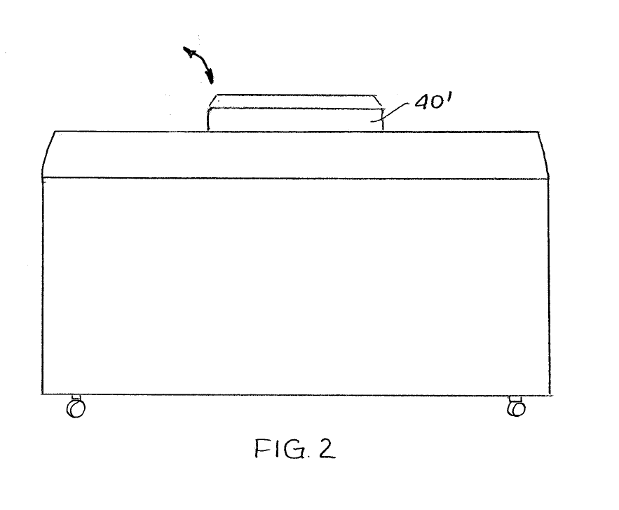

In another embodiment, such as that shown in FIG. 2, video display 40′ comprises a video projector of a known type, and may be used in conjunction with a screen (not shown). In such an embodiment, the flow height, or angle of incline, of video display 40′ may be adjusted. Such adjustment may be effected manually or automatically. As is known in the art, adjustment of the flow height may enable use of video display 40′ and, thus, of a presentation system including the same, with screens of different heights and sizes. Video display 40′ may also be adjusted to accommodate use of a presentation system in rooms of a wide variety of sizes.

In some embodiments, video display 40 may include only one video input port 41. Video input port 41 may have a somewhat unique configuration so that video display 40 may receive signals only from controller 30, and not from any other source, enabling restriction of the use of video display 40 and, thus, of presentation system 10 to users who have properly obtained access validation. In a more specific embodiment, input port 41 may comprise a “scrambled” connector (e.g., a scrambled VGA connector, etc.) with conductors (e.g., pins, etc.) arranged in a manner that differs from the standard arrangement of conductors in a similarly configured connector. In other embodiments, video input port 41 may have a nonstandard configuration. In still other embodiments, a permanent connection (rather than a removable cable) may establish communication between controller 30 and video display 40.

Sound system 50 may include a variety of components, including, but not limited to, an amplifier 53 and speakers 54. In embodiments where digital audio signals are conveyed from controller 30 to sound system 50, sound system 50 may also include a digital-to-analog converter 51 (which may comprise a stand-alone component or be part of another component, such as amplifier 53). In some embodiments, particularly where controller 30 is not the only source for sound (e.g., when a microphone, music player, or other audio source is to be used), sound system 50 may also include a mixer 52, which mixes audio signals from multiple sources before conveying the same to amplifier 53.

In some embodiments, speakers 54 may be extendable and retractable. Accordingly, such embodiments include speaker supports 55 that are configured to convey speakers 54 away from and toward the remainder of presentation system 10. Speaker supports 55 may be manually oriented relative to the remainder of presentation system 10 in some embodiments and, in other embodiments, they may be automatically oriented (e.g., by way of one or more motors 56, etc.) relative to the remainder of presentation system 10. When speaker supports 55 are configured for automatic orientation, their orientation may be specified through and controlled by controller 30.

In addition to the foregoing componentry, some embodiments of a presentation system 10 according to the present invention include a user access device 60. User access device 60 may communicate user access information to controller 30. Some embodiments of user access device 60 may be configured to read data from a user access element 62, such as a card, in a manner known in the art. One embodiment of such a user access device 60 is an optical scanner that scans and “reads” information from a bar code on a user access element 62. Another embodiment of user access device 60 that may be included in a presentation system 10 a magnetic card reader (e.g., a credit/debit card reader) that obtains information from a magnetic strip on a user access element 62. Of course, other embodiments of devices that restrict access to a presentation system 10 of the present invention are also within the scope of the present invention.

An embodiment of a method for setting up a presentation system 10 of the present invention consists essentially of (as minor adjustments may be made, and user access information may not be required) transporting presentation system 10 to a desired location in a room, providing power to presentation system 10 (e.g., plugging power cord 22 into an electrical outlet, etc.), turning presentation system 10 on, and establishing communication between a source 90 of digital video data and a controller 30 of presentation system 10. Communication between source 90 and controller 30 may consist of establishing a single communication link (e.g., one cord, a wireless connection, etc.) between source 90 and controller 30. Non-essentially, speakers 54 may be placed in a desired orientation, and the audio and video output of video display 40 and sound system 50 may be adjusted.

Use of presentation system 10 may merely include causing source 90 or controller 30 to play a digital video signal (which may include one or more corresponding audio signals). Some embodiments may additionally require that user access information, or data, be entered into controller 30 (e.g., manually, automatically, etc.) before presentation system 10 may be used.

When presentation system 10 is no longer needed, it may simply be turned off and power cord 22 disconnected from the external power source before being moved to a storage location.

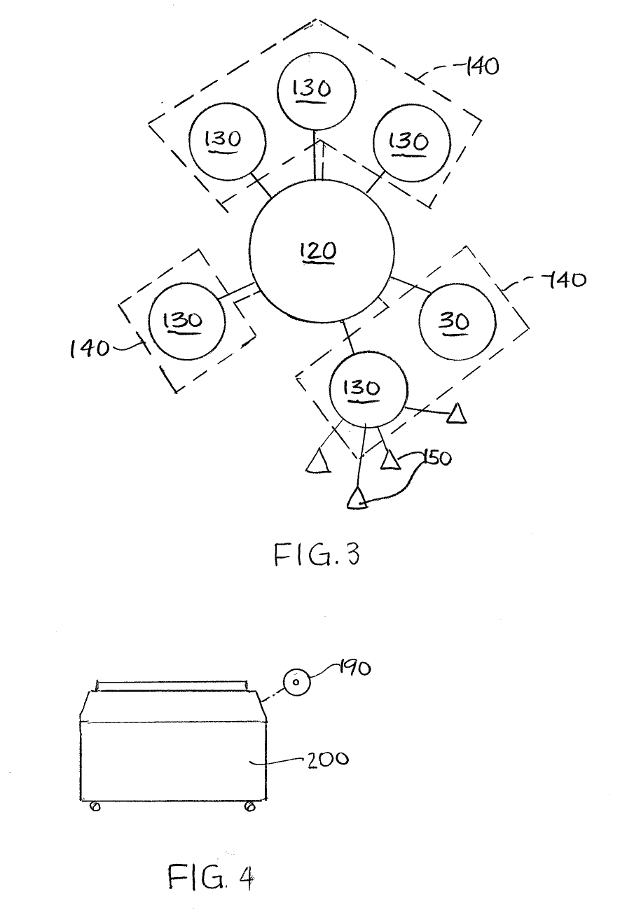

The diagram of FIG. 3 illustrates an embodiment of a network 110 by which audio/visual presentation systems are provided by an owner 120 to a number of facilitators 130. Each facilitator 130 has customers 150. In some embodiments, owner 120 also establishes relationships with one or more third party service providers 140, which may also be referred to herein as “dealers,” which provide support services to one or more facilitators 130.

Owner 120 has rights to a number of presentation systems. The presentation systems may, in some embodiments, belong to owner 120. In other embodiments, owner 120 may lease the presentation systems from another party. Owner 120 may, in some embodiments, bear responsibility for providing each facilitator 130 with technical support. In some embodiments, owner 120 may be responsible for maintaining, servicing, and replacing the presentation systems.

Owner 120 may contract with one or more service providers 140 to fulfill any obligations that owner 120 may have to maintain or service each presentation system and/or to provide technical support for the use of each presentation system. Each service provider 140 may be trained to use the presentation system that has been provided to a facilitator 130. A service provider 140 may also have the technical expertise to maintain and/or repair the presentation system, or they may have access to other parties with such technical expertise.

In addition, a service provider 140 may deliver presentation systems to each facilitator 130 for which it bears responsibility. In some embodiments, a service provider 140 serves as an intermediary between owner 120 and a facilitator 130, and may establish relationships between an owner 120 and various facilitators 130 with which presentation systems are placed.

Presentation systems are provided to each facilitator 130 by owner 120. In some embodiments, owner 120 provides one or more presentation systems directly to each facilitator 130. In other embodiments, owner 120 provides one or more presentation systems to a service provider 140, which then provides one or more presentation systems to one or more facilitators 130.

Upon taking possession of a presentation system, a facilitator 130 may agree to certain obligations. In some embodiments, facilitator 130 leases each presentation system from owner 120. Various embodiments of lease terms are within the scope of the present invention, and may include a minimum term for the lease, minimum monthly charges to facilitator 130, and the like. In a specific embodiment, a facilitator 130 agrees to compensate owner 120 by paying owner 120 a predetermined fee for each usage of a presentation system. The term “usage” may include, but is not necessarily limited to, situations in which a customer 150 of facilitator 130 obtained and paid for information to access a presentation system, but did not use the presentation system, as well as situations in which facilitator 130 allows a presentation to be used without compensation and, of course, situations in which facilitator 130 receives payment for the use of a presentation system and the presentation system is used. In a more specific embodiment, facilitator 130 agrees to pay owner 120 a minimum periodic (e.g., monthly, quarterly, annual, etc.) usage fee for each presentation system in facilitator 130's possession. In even more specific embodiments, the minimum periodic usage fee may be a fixed periodic fee or it may be based upon a certain number of expected uses during the period (e.g., three uses each month, etc.). In some embodiments where facilitator 130 is required to pay a minimum period fee, owner 120 may provide facilitator 130 with credit for paid for but unused sessions on a presentation system (e.g., if the presentation system is used only once during the period, but the fee paid by facilitator 130 for that period corresponds to the fee for three uses of the presentation system, facilitator 130 may not be required to pay additional money to owner 120 for the first two uses of that presentation system during the following period, although the minimum fee for that period will still apply).

Facilitator 130 may also, in some embodiments, be required to provide owner 120 or its agents (e.g., service provider 140, etc.) with access to each presentation system that has been placed in its possession. Such access may enable owner 120 to inspect its equipment, to confirm that facilitator 130 is meeting its payment obligations, or for any other suitable purpose.

Each use of a presentation system may be recorded by a system through which facilitator 130's customers 150 obtain a validation, or “access information,” that enables them to use the presentation system, by facilitator 130, or by the presentation system itself. Such a system may provide owner 120 with an accounting of the money due to owner 120 by each facilitator 130.

A customer 150 may obtain access to a presentation system by obtaining a validation. In some embodiments, the validation is embodied as a card with a bar code. In other embodiments, passcodes may be provided, validation information may be magnetically stored on an access card, or validation may be provided in any other manner that may be used with the presentation system to activate the same. Each validation may be configured to be used once. Corresponding validation may be stored in a controller of the presentation system or communicated to a controller of the presentation system in a manner known in the art. In some embodiments, a validation will activate a presentation system for a fixed duration (e.g., twelve hours, twenty-four hours, etc.).

The validation necessary to activate a presentation system may be obtained at an access point. In some embodiments, customer 150 obtains the validation through facilitator 130, which serves as the access point. Customers 150 of facilitator 130 may access a presentation system in facilitator 130's possession in any suitable manner.

In some embodiments, access to a presentation system may be provided through a web page. In a specific embodiment, facilitator 130, or an employee of facilitator 130, accesses the Internet, logs on to a validation web site (which may be owned by or under control of owner 120 or an agent of owner 120). Through the identification information that is used by facilitator 130, the validation web site may provide facilitator 130 with a list of presentation systems on facilitator 130's premises, along with information about the scheduling for each presentation system. Facilitator 130 may then select an available presentation system to which access is to be granted, enters information about the expected time and duration of usage, obtains access to the presentation system, and is billed for a use of the presentation system. In a specific embodiment, access to the available presentation system is obtained by selection of a “validate card” “button” on owner 120's validation web site, which causes a file to be sent to facilitator 130. Facilitator 130 may then print the file, with the printed file containing information necessary for a customer 150 to access the presentation system. The file may be printed onto an adhesive-coated label, which may then be secured to a more rigid card. The card may then be provided to the customer 150 upon payment of a rental fee to facilitator 130, and used by the customer 150 to activate the presentation system.

Facilitator 130 provides its customers 150 with physical access to a presentation system in its possession. In some embodiments, facilitator 130 transports a presentation system to a location (e.g., a meeting room, etc.) where it is to be used by a customer 150. Facilitator 130 may also assist its customers 150 in using a presentation system. Any service or support services may also be coordinated by facilitator 130, either directly through an assigned service provider 140 or indirectly through owner 120.

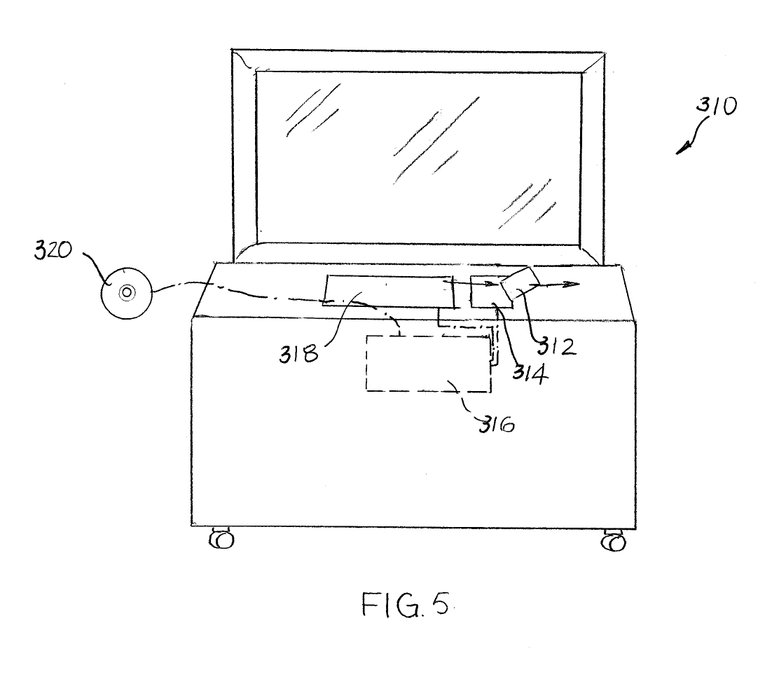

Referring now to FIG. 4, each customer 150 may provide its own source 190 of digital video data (which may also include digital audio data) for use with the presentation system 200. Various embodiments of sources 190 include computers, memory devices, video and/or audio players (e.g., digital video disk (DVD) players, other digital media devices, etc.). Customer 150 (FIG. 3) may establish communication between the source 190 and the presentation system 200 in any suitable manner. When the presentation system 200 comprises the embodiment described in reference to FIGS. 3 and 4, communication may be established by way of a single, simple connection, and presentation of the digital media supplied by the source 190 may be controlled by the user, in some embodiments without the assistance of technical personnel.

When an offsite meeting is to be conducted by a party, that party contacts a meeting facility, such as a convention center, an assembly hall, a hotel with conference rooms, or any other suitable facility for holding meeting. The meeting may include a media presentation, including video and audio components, and may, therefore, necessitate the use of audio/visual presentation equipment. For purposes of this disclosure, the party conducting the meeting is also referred to as a “user.”

In various embodiments of the present invention, when the user reserves space from a meeting facility, the user may also reserve a presentation system. The presentation system may be reserved for use on a particular date and, in some embodiments, reserved for a certain duration of time on that date. The presentation system may be reserved online (e.g., through the meeting facility's website, etc.), over the telephone, in person, or in any other suitable manner.

Once the reservation has been made, the meeting facility provides the user with an access validation. The access validation may be configured to provide the user with access to a specific presentation system (i.e., it may not be used with other presentation systems of the same type). The access validation may be configured for use only on the day that the user has reserved the presentation system. In some embodiments, the access validation is configured to be used only once. The access validation may provide a user with access to the presentation system for a predetermined period of time (e.g., twelve hours, twenty-four hours, etc.), which is also referred to herein as a “session.” In a more specific embodiment, once the access validation code is used to activate or actuate a presentation system, an internal clock will enable the presentation system to be used for a predetermined period of time. The presentation may be turned off, unplugged, and/or moved to a different location and turned back on during the predetermined period of time, but once the predetermined period of time has expired, operation of the presentation system ceases and, if further usage of the presentation system is desired, the user will be required to obtain additional access to the presentation system.

The access validation may be embodied in any suitable manner, such as in the form of an access card, an access code, or the like. In embodiments where the meeting facility provides the user with an access card, the card may include a bar code that embodies access information or data, a magnetic strip that carries access information or data, or any other suitable embodiment for carrying access information or data and conveying the same to a complementary access device (e.g., a bar code scanner, a magnetic card reader, etc.), or “reader,” associated with a controller of the presentation system. In embodiments where the access validation comprises a card with a bar code, the bar code may be printed onto an adhesive-coated label, which may then be secured to a more rigid card before being provided to the user.

In embodiments where the access validation comprises an access code, the access code may be entered into the controller (e.g., a computer, etc.) of the presentation system in any manner known in the art (e.g., manually, vocally, etc.).

With reference to FIG. 5, prior to conducting the meeting, the user may use the access validation 312 to activate or actuate the presentation system 310. The manner in which a user's access information or data is provided to presentation system 310 depends, of course, upon the form in which that access information is embodied (e.g., as a card, as a code, etc.). In the depicted embodiment, presentation system 310 includes an access device 314 for obtaining access information or data from an access validation 312 that comprises a card. Upon receiving the user's access information or data (from access device 314 in the illustrated embodiment), a controller 316 of presentation system 310 initiates a session, enabling activation and operation of the other components of presentation system 310.

The user may establish communication between presentation system 310 and an external source 320 of a digital media signal (e.g., a computer, a memory device, a memory card, a media player (e.g., a digital video disk (DVD) player, an MPEG-4 or mp4 player, etc.). Source 320 may belong to or otherwise be provided by the user. When the presentation system comprises an embodiment such as that described in reference to FIGS. 1 and 2, communication may be established by way of a single, simple connection, and presentation of the digital media supplied by source 320 may be controlled by the user, in some embodiments without the assistance of technical personnel. In some embodiments, communication may be established simply by connecting a single cable between source 320 and controller 316 of presentation system 310. In other embodiments, a wireless connection may be established between source 320 and controller 316. In embodiments where a memory card carries the digital media, the memory card may be inserted into an appropriate, complementary slot of controller 316. Of course, other techniques for quickly establishing a connection between a source 320 of digital media and controller 316 of presentation system 310 may also be used.

In some embodiments, the user may receive brief instructions on operation of the presentation system. In other embodiments, use of the presentation system is intuitive, merely requiring that the user interact with instructions provided by a user interface 318 of or associated with controller 316, and, therefore, requires little or no instruction.

The user may then use presentation system 310 to present the digital media from source 320 at any time while the user's session on presentation system 310 remains active.

Although the foregoing description contains many specifics, these should not be construed as limiting the scope of the present invention, but merely as providing illustrations of some embodiments. Similarly, other embodiments of the invention may be devised which do not exceed the scope of the present invention. Features from different embodiments may be employed in combination. The scope of the invention is, therefore, indicated and limited only by the appended claims and their legal equivalents, rather than by the foregoing description. All additions, deletions and modifications to the invention as disclosed herein which fall within the meaning and scope of the claims are to be embraced thereby.

What is claimed:

1. A self-contained presentation system, comprising:
a controller configured to receive at least an external video signal;
a video display in communication with the controller for receiving at least a video signal from the controller; and
a sound system, including:
a mixer in communication with at least one of the controller, the video display, and an external audio source so as to receive at least one audio signal from the at least one controller, the video display, or the external audio source;
an amplifier in communication with the mixer for receiving at least one mixed audio signal from the mixer; and
at least one speaker in communication with the amplifier for receiving a mixed at least one amplified audio signal from the amplifier;
a frame carrying the controller, the video display, and the sound system; and
a housing at least partially covering the frame.

2. The self-contained presentation system of claim 1, wherein the video display includes a single input consisting of a VGA connector with an unconventional pin arrangement to limit signal inputs into the video display to signals from the controller.

3. The self-contained presentation system of claim 2, wherein the controller only communicates a video signal to the video display.

4. The self-contained presentation system of claim 1, wherein the at least one speaker of the sound system is configured to extend outwardly from the frame.

5. The self-contained presentation system of claim 1, further comprising:
a microphone for generating an additional audio signal for communication to the mixer of the sound system through the auxiliary input of the mixer.

6. The self-contained presentation system of claim 1, further comprising:
a transport system associated with the frame for enabling movement of the frame, the housing, and components carried by the frame or contained within the housing.

7. The self-contained presentation system of claim 1, further comprising:
a user access device in communication with the controller for enabling operation of the controller, the video display and the sound system.

8. The self-contained presentation system of claim 17, wherein the user access device comprises a card reader for obtaining information from a user access card.

9. A system for providing video presentation services to customers of facilitator, comprising:
a video presentation system of an owner and placed in possession of a facilitator;
an access point accessible through the facilitator, the access point configured to enable a customer to compensate the facilitator for customer access information for activating the video presentation system at the facilitator; and
a source of digital video data owned by the customer and configured to communicate with a controller of the video presentation system.

10. The system of claim 9, wherein the video presentation system comprises:
a video display;
a sound system;
a controller configured to receive at least an external video signal and at least one external audio signal and to communicate only video signals to the video display and only audio signals to the sound system; and
a customer access device in communication with the controller for enabling operation of the controller, the video display and the sound system.

11. The system of claim 9, wherein the access point includes a printer for printing the customer access information.

12. The system of claim 9, further comprising:
an adhesive-coated label on which the customer access information is to be printed.

13. The system of claim 12, further comprising:
a card for receiving the adhesive-coating label.

14. A video presentation method, consisting essentially of:
transporting a single frame including the entire presentation system into a room where a conference is to be conducted;
simultaneously connecting all electronic components of the presentation system to a power source;
activating a controller of the presentation system by entering user access information into a user access component associated with the controller;
coupling a source of digital video data to the controller; and
causing a video display of the presentation system to display video corresponding to the digital video data.

15. The video presentation method of claim 14, wherein coupling the source of digital video data to the controller consists of establishing communication between a computer and the controller.

16. The video presentation method of claim 14, wherein coupling the source of digital video data to the controller consists of coupling a memory device to the controller.

17. The video presentation method of claim 14, wherein activating the controller includes reading the user access information from a user access card.
